(19) United States
(12) Patent Application Publication
(10) Pub. No.: US 2026/0166884 A1
(43) Pub. Date: Jun. 18, 2026

(54) INK EJECTION HEAD AND INKJET PRINTER

(71) Applicant: SCREEN Holdings Co., Ltd., Kyoto (JP)

(72) Inventors: Takashi KURODA, Kyoto (JP); Tamio FUKUI, Kyoto (JP); Masahiro TOKUYAMA, Kyoto (JP)

(21) Appl. No.: 18/707,856

(22) PCT Filed: Oct. 28, 2022
(86) PCT No.: PCT/JP2022/040533

§ 371 Date: May 6, 2024

(30) Foreign Application Priority Data
Nov. 8, 2021 (JP) 2021-182065

(51) Int. Cl. B41J 2/17; B41J 2/175; B41J 29/377

(52) U.S. Cl. CPC B41J 2/1714; B41J 2/175; B41J 29/377

(57) ABSTRACT

A technique is provided for reducing the adhesion of ink mist to a device by producing a uniform airflow at a desired rate above a base material, irrespective of the shape of ink ejection heads or the layout of lines or wiring around the ink ejection heads. A ink ejection head includes an ink ejection outlet group including a plurality of ink ejection outlets from which ink is ejected toward a base material, an air outlet that is located downstream of the ink ejection outlet group in the transport direction and from which air is ejected toward the base material, and an air line through which air is supplied toward the air outlet. The air outlet is provided in close proximity to an ink ejection outlet that is located on the most downstream side in the transport direction among the ink ejection outlets included in the ink ejection outlet group. The air outlet is not provided in close proximity to an ink ejection outlet that is located on the most upstream side in the transport direction among the ink ejection outlets included in the ink ejection outlet group.

### TECHNICAL FIELD

The present invention relates to an ink ejection head and an inkjet printer.

### BACKGROUND ART

In inkjet printers, it is known that ink mist is produced when microdroplets of ink are ejected onto a base material. If ink mist adheres to and accumulates on the inside of the printer such as around ink ejection outlets, for example, the ink mist may drop on the base material in the form of large ink droplets and may cause deterioration in print quality.

Patent Literature (PTL) 1 describes that slit through holes (airflow orifices) are provided adjacent to the downstream side of ink ejection heads in the direction of transport of a base material, the airflow orifices having air outlets that are open in the vicinity of the lower ends of the ink ejection heads. In the vicinity of the airflow orifices, a fan is provided so that air brown from the fan into the airflow orifices is exhausted through the air outlets and causes ink mist that is floating above the base material to adhere to the base material. This reduces the adhesion of the ink mist to the inside of a device.

### CITATION LIST

### Patent Literature

PTL 1: Japanese Patent Application Laid-Open No. 2021-74998

### SUMMARY OF INVENTION

### Technical Problem

In the case of conventional technology, however, wiring and lines such as ink supply lines are run through around ink ejection heads, and it may be difficult to create a uniform airflow along the entire width of a base material. It may also be difficult to provide airflow orifices at appropriate positions depending on the shape of the ink ejection heads.

It is an object of the present invention to provide a technique that allows reducing the adhesion of ink mist to an inkjet printer by creating a uniform airflow at a desired speed on a base material, irrespective of the shape of ink ejection heads and the layout of lines or wiring around the ink ejection heads.

### Solution to Problem

To solve the problem described above, a first aspect of the present application is an ink ejection head for ejecting ink onto a base material that is transported in a transport direction along a transport path. The ink ejection head includes an ink ejection outlet group that includes a plurality of ink ejection outlets from which ink is ejected toward the base material, an air outlet that is located downstream of the ink ejection outlet group in the transport direction and from which air is ejected toward the base material, an ink line through which ink is supplied toward the plurality of ink ejection outlets, and an air line through which air is supplied toward the air outlet. The air outlet is provided in close proximity to an ink ejection outlet that is located on a most downstream side in the transport direction among the plurality of ink ejection outlets included in the ink ejection outlet group, and the air outlet is not provided in close proximity to an ink ejection outlet that is located on a most upstream side in the transport direction among the plurality of ink ejection outlets included in the ink ejection outlet group.

A second aspect of the present application is the ink ejection head according to the first aspect, in which the air outlet is provided at an interval of 7.8 mm or less in the transport direction from the ink ejection outlet that is located on the most downstream side in the transport direction among the plurality of ink ejection outlets included in the ink ejection outlet group, and the air outlet is not provided in a region that is within a distance of 7.8 mm or less on the upstream side in the transport direction from the ink ejection outlet that is located on the most upstream side in the transport direction among the plurality of ink ejection outlets included in the ink ejection outlet group.

A third aspect of the present application is the ink ejection head according to the second aspect, in which the air outlet is provided at an interval of 1.4 mm or less or at an interval of 5 mm or more and 7.8 mm or less in the transport direction from the ink ejection outlet that is located on the most downstream side in the transport direction among the plurality of ink ejection outlets included in the ink ejection outlet group.

A fourth aspect of the present application is the ink ejection head according to any one of the first to third aspects, in which air is ejected from the air outlet at a speed of higher than or equal to 0.1 m/s and lower than or equal to 0.55 m/s.

A fifth aspect of the present application is the ink ejection head according to any one of the first to fourth aspects. The ink ejection head further includes a filter member located inside the air line and having air permeability.

A sixth aspect of the present application is the ink ejection head according to any one of the first to fifth aspects. The ink ejection head further includes straightening values located inside the air line and for rectifying a flow of air passing through an interior of the air line.

A seventh aspect of the present application is an inkjet printer that includes a base-material transport mechanism for transporting a base material in a transport direction along a transport path, an image recorder that holds the ink ejection head according to any one of the first to sixth aspects, an ink supply line through which ink is supplied toward the ink line provided in the image recorder, and an air supply line through which air is supplied toward the air line provided in the image recorder.

### Advantageous Effects of Invention

According to the first to seventh aspects of the present invention described in the present application, air can be fed directly from the air line to the air outlet. This allows the creation of a uniform airflow at a desired speed above the base material and reduces the occurrence of adhesion of the ink mist to the inkjet printer, irrespective of the shape of the ink ejection heads and the layout of lines or wiring around the ink ejection heads.

In particular according to the fourth aspect of the present application, the airflow ejected out through the air outlet can be pressed against the base material so as to reduce the occurrence of adhesion of the ink mist to the inkjet printer.

In particular, according to the fifth aspect of the present application, the filter member having air permeability is provided inside the air line so as to increase pressure loss in the air line. This makes uniform the airflow inside the air line.

In particular, according to the sixth aspect of the present application, the straightening values for rectifying the airflow are provided in the air line so as to increase pressure loss in the air line. This makes uniform the airflow inside the air line.

### BRIEF DESCRIPTION OF DRAWINGS

FIG. 1 is a diagram showing a schematic configuration of an inkjet printer.

FIG. 2 is a longitudinal sectional view of an image recorder and a support unit.

FIG. 3 is a plan view showing the image recorder.

FIG. 4 is a perspective view showing a base plate and ink ejection heads.

FIG. 5 is a diagram showing the lower surfaces of the ink ejection heads and the lower surface of the base plate.

FIG. 6 is a longitudinal sectional view showing an area around an air line and an air outlet in enlarged dimensions.

FIG. 7 is a diagram showing the result of simulating the behavior of ink mist.

FIG. 8 is a graph showing the result of simulating the behavior of ink mist.

FIG. 9 is a diagram showing the result of simulating the behavior of ink mist.

FIG. 10 is a graph showing the result of simulating the behavior of the ink mist.

FIG. 11 is a partial sectional view of an ink ejection head when a filter member is provided inside the air line.

FIG. 12 is a partial sectional view of an ink ejection head when straightening vanes are provided inside the air line.

FIG. 13 is a bottom view of ink ejection heads according to a variation.

### DESCRIPTION OF EMBODIMENT

Hereinafter, an embodiment of the present invention will be described with reference to the accompanying drawings. Note that constituent elements described in this embodiment are mere examples and do not intend to limit the scope of the present invention thereto. To facilitate understanding of the drawings, the dimensions or number of each constituent element may be exaggerated or simplified as necessary in the illustration.

### 1. Embodiment

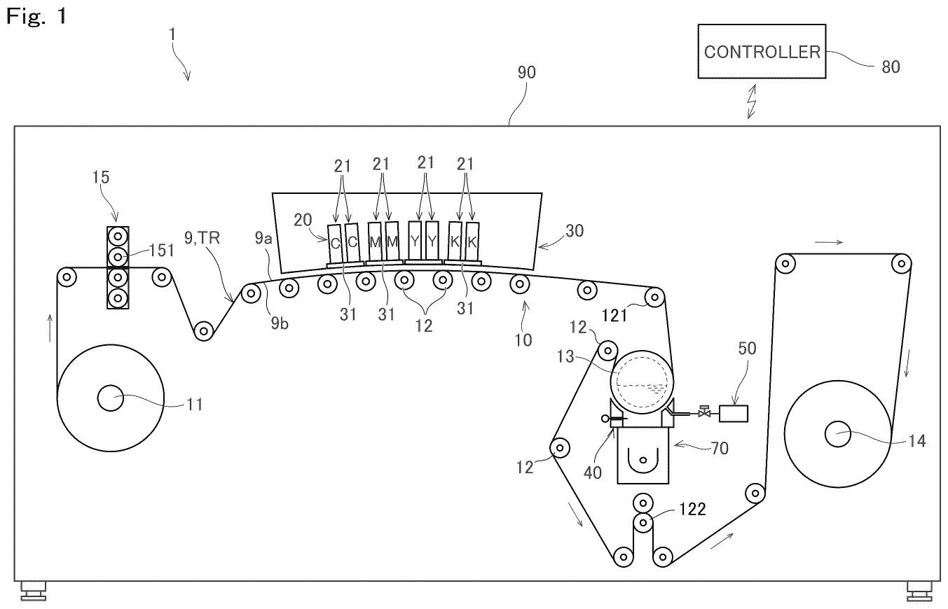

FIG. 1 is a diagram showing a schematic configuration of an inkjet printer 1 according to an embodiment. The inkjet printer 1 is a device that forms an image on a recording surface 9a of a band-like base material 9 (e.g., printing paper) by ejecting droplets of ink (ink droplets) from a plurality of ink ejection heads 21 while transporting the base material 9. The inkjet printer 1 uses ultraviolet ray-curable ink (UV-curable ink) that is cured upon irradiation with ultraviolet rays, which are electromagnetic waves. The UV-curable ink may contain a curing initiator for accelerating curing as a component. Note that the inkjet printer 1 may use different ink other than the UV-curable ink (e.g., water-based ink or oil-based ink).

The inkjet printer 1 includes a base-material transport mechanism 10, an image recorder 20, a support unit 30, a treatment room 40, an inert-gas supplier 50, an irradiator 70, and a controller 80. The constituent elements other than the controller 80 (including the image recorder 20 and the treatment room 40) are placed in a box-like device case 90.

The base-material transport mechanism 10 is a mechanism for transporting the base material 9 in a direction along the length of the base material 9 (longitudinal direction). The base-material transport mechanism 10 includes an unwinder 11, a plurality of transport rollers 12, a chilling roller 13, and a rewinder 14. The transport rollers 12 include a switching roller 121 and a nip roller 122, which will be described later. The base material 9 is unreeled from the unwinder 11 and transported along a transport path configured by the transport rollers 12. Each transport roller 12 guides the base material 9 to the downstream side in the direction of travel by rotating around a horizontal axis. The base transported material 9 is collected by the rewinder 14. In this way, the base material 9 is transported along a prescribed transport path TR while being supported by the rollers such as the transport rollers 12 and the chilling roller 13 arranged at preset positions.

In the following description, the direction of travel of the base material 9 along the transport path TR is simply referred to as the “transport direction.” The downstream side in the transport direction is simply referred to as the “downstream side,” and the upstream side in the transport direction is simply referred to as the “upstream side.” Moreover, a direction that is orthogonal to the transport direction and is parallel to the surface of the base material 9 is referred to as the “width direction.”

As shown in FIG. 1, the base material 9 after unreeled from the unwinder 11 firstly passes through a cleaner 15. The cleaner 15 includes a plurality of adsorption rolls 151 arranged vertically in close proximity to one another. The adsorption rolls 151 rotate in contact with the recording surface 9a and a back surface 9b of the base material 9. Foreign materials adhering to the recording surface 9a and the back surface 9b are absorbed and removed by the adsorption rolls 151. This reduces the number of foreign materials adhering to the base material 9 before printing. Thus, it is possible to reduce the occurrence of print defects such as rejection or seepage of ink due to foreign materials. Note that the cleaner 15 may use a different system such as a suction mechanism other than the adsorption rolls 151.

The base material 9 that has passed through the cleaner 15 moves approximately horizontally in the direction of alignment of the ink ejection heads 21 under the image recorder 20. At this time, the recording surface 9a of the base material 9 faces upward (toward the ink ejection heads 21). The switching roller 121, the chilling roller 13, and the nip roller 122 are arranged downstream of the image recorder 20.

Although not shown, an antistatic mechanism (ionizer) is arranged downstream of the cleaner 15 and upstream of the image recorder 20. The antistatic mechanism removes static electricity from the base material 9. Since the cleaner 15 and the antistatic mechanism are arranged upstream of the image recorder 20 in this way, it is possible to supply the base material 9 from which foreign materials and static electricity have been removed, to the image recorder 20.

The nip roller 122 actively rotates at a constant speed while grasping the base material 9 in contact with the recording surface 9a and the back surface 9b of the base material 9. The base-material transport mechanism 10 adjusts the rotational speed of the unwinder 11 relative to the rotational speed of the nip roller 122. This applies tension to the base material 9. As a result, it is possible to suppress the occurrence of slack or creases in the base material 9 during transport.

The image recorder 20 is a mechanism for ejecting UV-curable ink to the base material 9 that is being transported by the base-material transport mechanism 10. The image recorder 20 includes four types of ink ejection heads 21 that eject different colors of ink. The ink ejection heads 21 are aligned in the travel direction of the base material 9. At the time of printing, droplets of color ink including cyan (C), magenta (M), yellow (Y), and black (K), which become color components of a color image, are ejected respectively from the four types of ink ejection heads 21 toward the recording surface 9a of the base material 9. Accordingly, the color image is formed on the recording surface 9a of the base material 9. Note that the inkjet printer 1 may further include other ink ejection heads that eject ink of any other color (e.g., white).

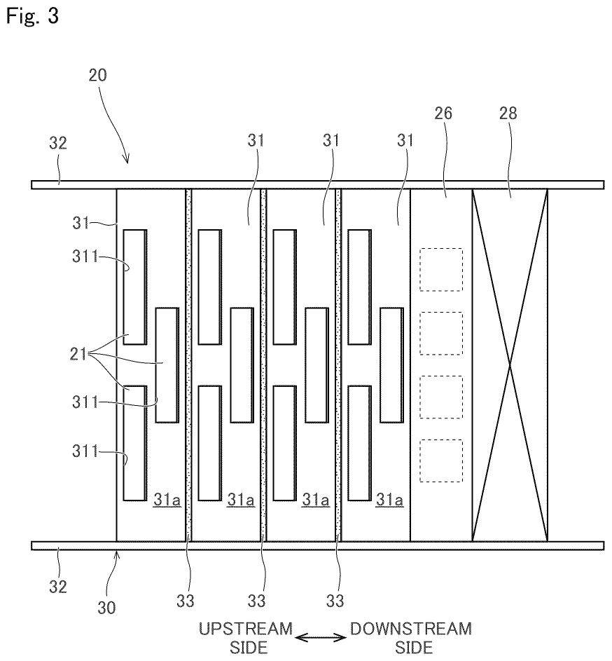

The support unit 30 includes a plurality of base plates 31 that are aligned along the transport path TR of the base material 9 and a pair of support frames 32 (see FIG. 3) that support both edges of each base plate 31 in the width direction. The pair of support frames 32 extends approximately in parallel with the transport path TR and is arranged in parallel with each other at an interval in the width direction. The base plates 31 are arranged at intervals in the transport direction.

Each ink ejection head 21 is mounted on one of the base plates 31. This configuration allows each ink ejection head 21 to be supported, and fixes the relative positional relationship of the ink ejection heads 21. Each base plate 31 has through holes (attachment holes 311 described later) in which the lower ends of the ink ejection heads 21 are fitted. Thus, lower surfaces 212 of the ink ejection heads 21 attached to the base plates 31 face the recording surface 9a of the base material 9 without being obstructed by the base plates 31. More detailed structures of the image recorder 20 and the support unit 30 will be described later.

As shown in FIG. 1, the switching roller 121 is arranged downstream of the image recorder 20. The switching roller 121 rotates about a horizontal axis extending in the width direction while being in contact with the back surface 9b of the base material 9. Accordingly, the base material 9 is bent in a direction opposite to the recording surface 9a. As a result, the travel direction of the base material 9 is switched from a first direction (in the present embodiment, an approximately horizontal direction) to a second direction (in the present embodiment, a vertically downward direction).

The switching roller 121 is in contact with the back surface 9b of the base material 9. Thus, the surface of the switching roller 121 does not come in contact with uncured ink. This prevents deterioration in the quality of the image formed on the base material 9 due to contact with the switching roller 121. On the recording surface 9a of the base material 9, there is no member provided to switch the travel direction of the base material 9.

The chilling roller 13 rotates about a horizontal axis extending in the width direction while being in contact with the back surface 9b of the base material 9. The chilling roller 13 is arranged approximately vertically above the treatment room 40 and the irradiator 70. The diameter of the outer peripheral surface of the chilling roller 13 is greater than the diameters of the transport rollers 12 arranged before and after the chilling roller 13. The chilling roller 13 stores cooling water therein. The cooling water is circulated as appropriate by a circulator, which is not shown. Accordingly, the surface of the chilling roller 13 is cooled and maintained at a constant temperature.

The treatment room 40 is arranged downstream of the image recorder 20. The treatment room 40 has an import outlet and an export outlet that allow passage of the base material 9. The top of the treatment room 40 is covered with the outer peripheral surface of the chilling roller 13.

The inert-gas supplier 50 fills the inside of the treatment room 40 with high-concentration inert gas by supplying inert gas (e.g., nitrogen gas) to the inside of the treatment room 40. To be more specific, the inert-gas supplier 50 supplies nitrogen gas, which is inert gas, toward the recording surface 9a of the base material 9 that is present inside the treatment room 40.

The irradiator 70 is arranged downward of the inert-gas supplier 50 and approximately vertically under the chilling roller 13. The irradiator 70 is also arranged immediately under the treatment room 40. The irradiator 70 performs irradiation processing for applying irradiation light to the base material 9 supported by the chilling roller 13. The irradiation light emitted from the irradiator 70 contains ultraviolet rays with wavebands effective for ink curing and has an enough light quantity. When the ink on the base material 9 is subjected to the irradiation processing, the ink is cured and fixed on the base material 9. In this way, the image is recorded on the recording surface 9a of the base material 9.

The controller 80 is configured as a computer that includes an arithmetic processor such as a CPU, memory such as RAM, and a storage such as a hard disk drive. For example, the controller 80 may be electrically connected to constituent elements such as the unwinder 11, the rewinder 14, the ink ejection heads 21, the irradiator 70, the nip roller 122, a compressor 171 which will be described later, and a regulator 172 which will be described later. The controller 80 controls the operations of the constituent elements described above by temporarily reading out computer programs stored in the storage into the memory and causing the arithmetic processor to perform arithmetic processing in accordance with the computer programs. The print processing by the inkjet printer 1 proceeds under this control.

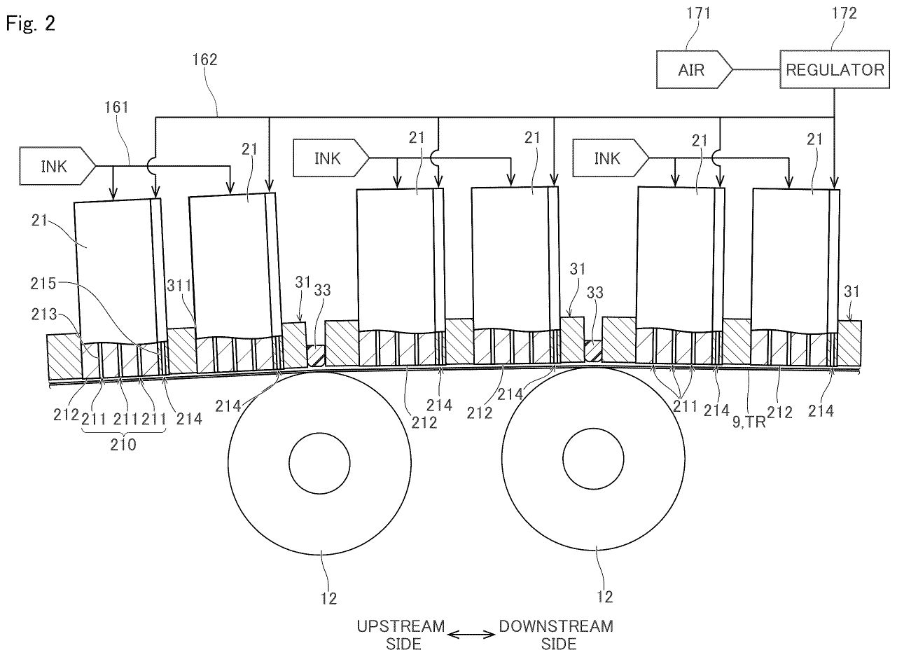

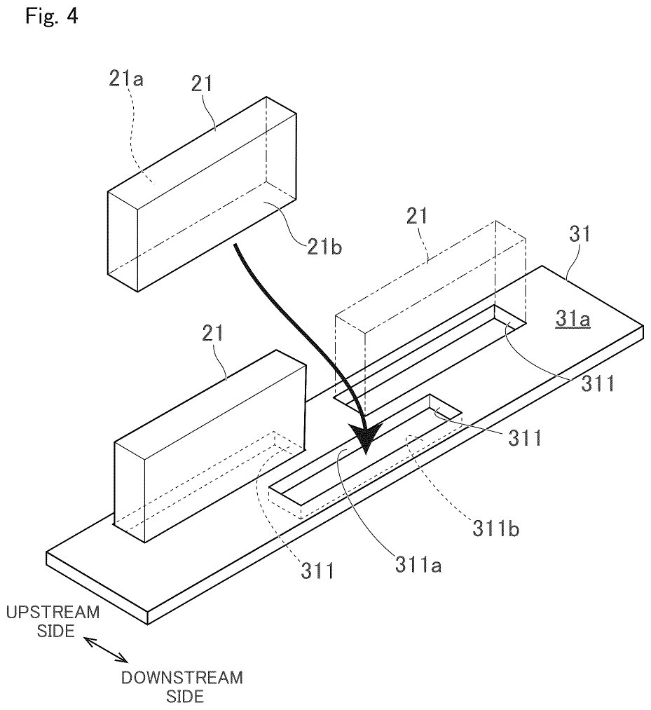

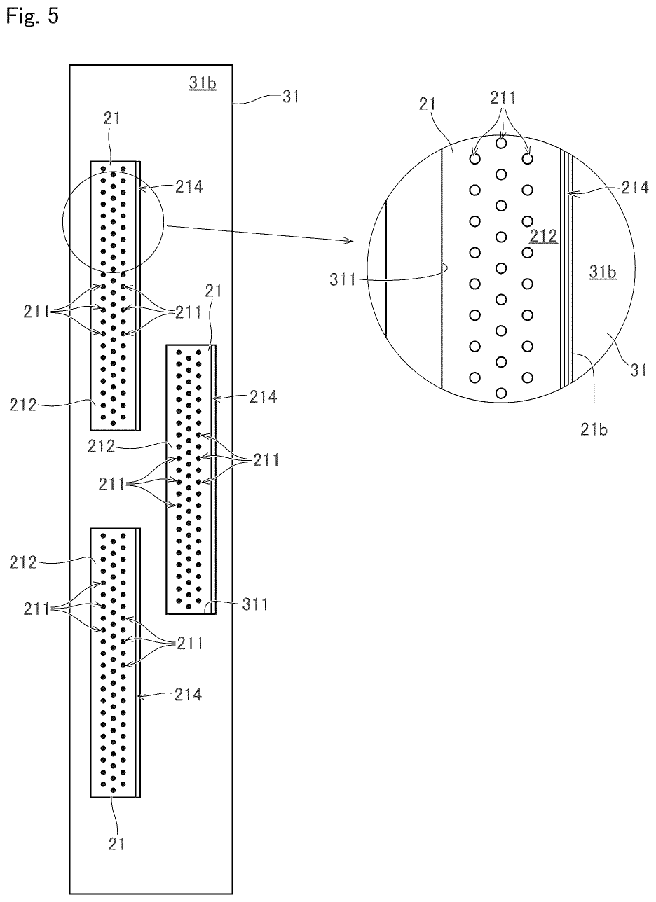

FIG. 2 is a longitudinal sectional view of the image recorder 20 and the support unit 30. FIG. 3 is a plan view showing the image recorder 20. FIG. 4 is a perspective view showing one base plate 31 and the ink ejection heads 21. FIG. 5 is a diagram showing the lower surfaces 212 of the ink ejection heads 21 and a lower surface 31b of one base plate 31.

As shown in FIGS. 2 and 5, a plurality of ink ejection heads 21 are arranged above the transport path TR. Each ink ejection head 21 has a lower surface 212. The lower surfaces 212 of the ink ejection heads 21 face the transport path TR. Each ink ejection head 21 includes a plurality of ink lines 213. The ink lines 213 are open toward the transport path TR at the lower surface 212 and form a plurality of ink ejection outlets 211 through which ink droplets are ejected. The ink ejection outlets 211 are aligned at regular intervals in both of the width direction and the transport direction and form an ink ejection outlet group 210. An air line 215 is provided on the downstream side face of each ink ejection head 21. The air line 215 is open in a slit extending in the width direction at the lower surface 212 of the ink ejection head 21 and forms an air outlet 214. As shown in FIG. 2, each ink ejection head 21 is fixedly attached to the base plate 31 with its lower end fitted in one attachment hole 311 formed in the base plate 31. The lower surface 212 of each ink ejection head 21 is a flat surface provided with the ink ejection outlet group 210 and the air outlet 214. The lower surface 212 is arranged in almost parallel with the recording surface 9a of the base material 9.

As shown in FIGS. 1 and 2, a plurality of transport rollers 12 that are provided immediately under the image recorder 20 are arranged in a convex arc shape. Thus, the base material 9 that is being transported immediately under the image recorder 20 is curved upwardly (toward the recording surface 9a) in a convex shape. That is, the transport path TR immediately under the image recorder 20 curves upwardly in a convex shape. The base plates 31 are aligned in the curved shape of the transport path TR, and accordingly the ink ejection heads 21 are also arranged in an arc shape along the transport path TR.

As shown in FIG. 4, each base plate 31 is a plate-like members having a rectangular shape in plan view. The base plate 31 has three attachment holes 311 that penetrate the base plate 31 in the thickness direction. The attachment holes 311 are open in a rectangular shape extending in the width direction at the upper and lower surfaces 31a and 31b of the base plate 31. Among the three attachment holes 311, two attachment holes 311 are located on the upstream side, and the remaining one is located on the downstream side. The two upstream attachment holes 311 are located at an interval in the width direction, and the downstream attachment hole 311 is arranged in the center of the two upstream attachment holes 311 in the width direction. Both ends of the downstream attachment hole 311 in the width direction are arranged overlapping the two upstream attachment holes 311 in the transport direction. In the following description, upstream inner walls of the attachment holes 311 are referred to as inner walls 311a, and downstream inner walls thereof are referred to as inner walls 311b.

Each of the three attachment holes 311 receives insertion of the lower end of one ink ejection head 21 having a rectangular shape in plane view, and the ink ejection head 21 is fixedly attached the attachment hole via a fastening device such as a screw. The ink ejection head 21 is fixedly attached to the attachment hole 311 such that its air outlet 214 is arranged downstream of the ink ejection outlet group 210. Clearance between the lower end of the ink ejection head 21 and the base plate 31 is sealed by a seal member, which is not shown. Specifically, the ink ejection head 21 is fitted in the attachment hole 311 while an upstream side face 21a of the ink ejection head 21 faces the upstream inner wall 311a of the attachment hole 311 and a downstream side face 21b of the ink ejection head 21 faces the downstream inner wall 311b of the attachment hole 311.

As shown in FIG. 2, the upper end of each ink ejection head 21 is connected to an ink supply line 161 and an air supply line 162. The ink supply line 161 is connected to the ink line 213 of the ink ejection head 21 and supplies ink to the ink ejection head 21. The air supply line 162 is connected to the air line 215 of the ink ejection head 21 and supplies air to the ink ejection head 21. The upper end of each ink ejection head 21 may also be connected to an ink discharge line for circulating the ink. Note that the ink supply line 161, the ink discharge line, and the air supply line 162 may be connected from any other portion of the ink ejection head 21 other than the upper end to each ink ejection head 21.

As shown in FIG. 2, the air supply line 162 is connected to the compressor 171 that supplies high-pressure air. The regulator 172 for controlling the pressure of the air supplied from the compressor 171 is provided between the air supply line 162 and the compressor 171. The air supplied from the compressor 171 is subjected to pressure regulation by the regulator 172 and is supplied to the air supply line 162. Note that a different compressor 171 and a different regulator 172 may be provided for each of the air outlets 214. In this case, it is possible to eject air at a different flow rate from each air outlet 214.

Each air line 215 forms a flow path of air from the air supply line 162 toward the air outlet 214. The air line 215 is also open at the lower surface 212 and forms the air outlet 214. The air outlet 214 is arranged adjacent to the downstream side of the ink ejection outlet 211 that is located on the most downstream side among the ink ejection outlets 211 configuring the ink ejection outlet group 210. The air outlet 214 ejects air toward the base material 9 that is being transported along the transport path. Accordingly, a uniform airflow is created above the base material 9.

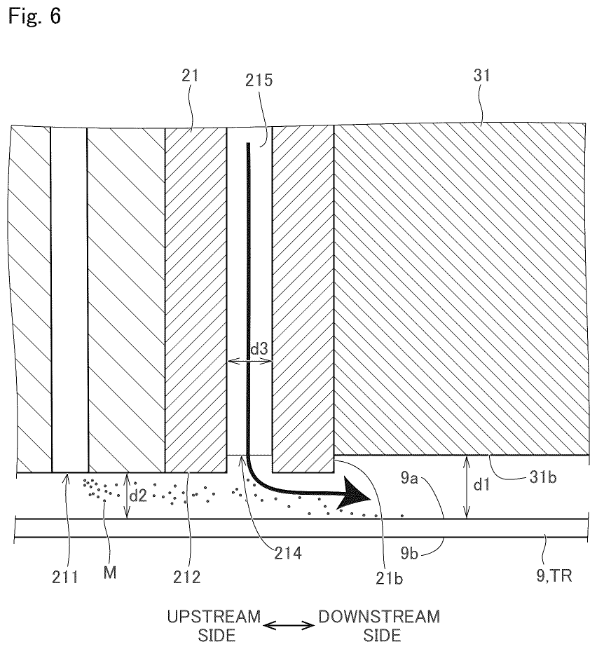

FIG. 6 is a longitudinal sectional view showing an area around one air line 215 and one air outlet 214 in enlarged dimensions. As shown in FIG. 6, the air line 215, which is short in the transport direction and long in the width direction, is formed in a portion of the ink ejection head 21 that is in close proximity to the downstream side face 21b. The lower end of the air line 215 is open toward the base material 9 and serves as an air outlet 214. Thus, when horizontally viewed, the air outlet 214 has a slit shape that is short in the transport direction and long in the width direction.

As shown in FIG. 6, ink mist M that is produced from ink droplets or the like ejected from the ink ejection outlets 211 floats between the base material 9 and the lower surface 212 of the ink ejection head 21 and then floats to the downstream side along with the movement of the base material 9. In this state, when air is ejected from the air outlet 214, the ink mist M that is floating above the base material 9 is caused to adhere to the base material 9. This reduces the adhesion of the ink mist M to the lower surface 212 of the ink ejection head 21 or the lower surface 31b of the base plate 31. Note that the amount of the ink mist M is extremely smaller than the amount of the ink droplets ejected from the ink ejection outlets 211 to form an image. Thus, even if the ink mist M adheres to the base material 9, the degree of deterioration in print quality is small. Besides, since it is possible to reduce the adhesion of the ink mist M to the lower surface 212 of the ink ejection head 21 and the lower surface 31b of the base plate 31, the frequency of cleaning to be done by the user can be reduced.

As shown in FIGS. 2 and 3, a seal member 33 is provided between every pair of base plates 31 adjacent in the transport direction. The seal member 33 extends in the width direction and blocks clearance between the adjacent base plates 31. The presence of the seal member 33 reduces the occurrence of an airflow in the clearance between each pair of adjacent base plates 31. This reduces the possibility that the airflow above the base material 9 may become disturbed between the base plates 31.

It is desirable that the lower surface of the seal member 33 is flush with (the same in height as) the lower surfaces 31b of the base plates 31 located on both the upstream and downstream sides of the seal member 33. This suppresses the occurrence of a turbulent flow or the like between the base plates 31 and accordingly reduces the adhesion of the ink mist M to the base plates 31.

As shown in FIG. 3, the image recorder 20 includes a light irradiator 26 and an aspirator 28. The light irradiator 26 includes a light source such as an LED and irradiates the recording surface 9a of the base material 9 with light emitted from the light source. The light irradiator 26 is arranged downstream of the ink ejection head 21 that is located on the most downstream side, and is configured to semi-cure the ink ejected onto the base material 9.

Although not shown, the aspirator 28 has a slit-like aspiration hole that faces the recording surface 9a of the base material 9 and aspirates air from the aspiration hole. Since the aspirator 28 aspirates air on the downstream side of the four base plates 31, it is possible to easily form an airflow flowing to the downstream between each base plate 31 and the base material 9. This allows the ink mist M produced around each ink ejection outlet 211 to float to the downstream side.

Note that the provision of the aspirator 28 in the vicinity of the light irradiator 26 is not essential, and for example, the aspirator 28 may be provided at a position in the vicinity of, for example, the switching roller 121. The provision of the aspirator 28 downstream of the light irradiator 26 is also not essential, and the aspirator 28 may be provided upstream of the light irradiator 26.

As shown in FIG. 5, the air outlets 214 extend in the width direction. The length of the air outlets 214 in the width direction almost matches the length of the lower surfaces 212 of the ink ejection heads 21 in the width direction. The air outlets 214 extend outward of the ink ejection outlet groups 210 in the width direction, the ink ejection outlet groups 210 being adjacent to the air outlets 214 on the upstream side. Thus, even if the ink mist M is produced from any of the ink ejection outlets 211, the ink mist M can be caused to adhere to the base material 9 by the downflow of air from the air outlets 214. This reduces the adhesion of the ink mist M to the lower surface 31b of the base plate 31 on which the ink ejection heads 21 are provided, and also to, for example, the lower surfaces 31b of the base plates 31 that are located on the further downstream side.

Next, description is given of the position of the air outlets 214 and the ejection speed of air ejected from the air outlets 214 in order to allow effective adhesion of the ink mist M to the base material 9 and to further reduce the adhesion of the ink mist M to, for example, the lower surfaces 31b of the base plates 31. In the following description, among the array of a plurality of ink ejection outlets 211 configuring one ink ejection outlet group 210, the most upstream column is referred to as the “forefront column,” and the most downstream column is referred to as the “rearmost column.”

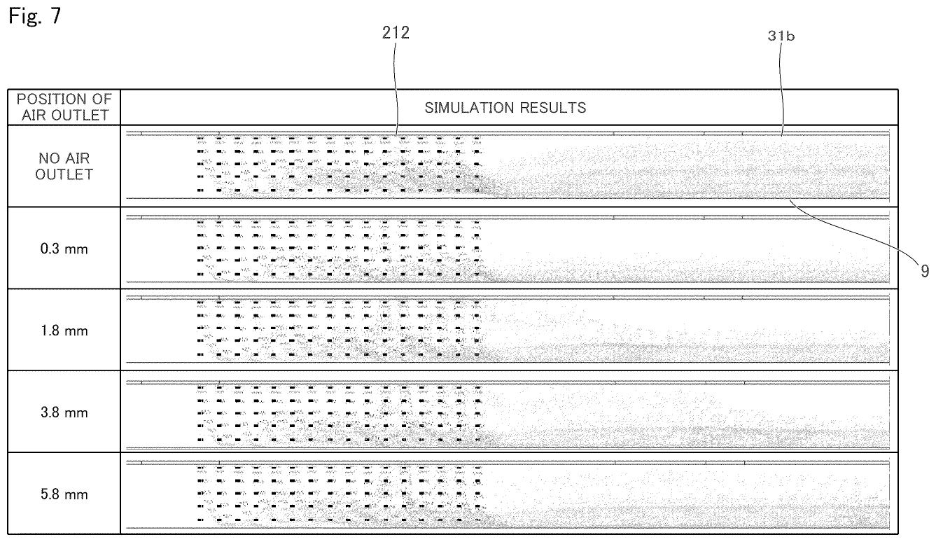

FIG. 7 shows comparison of the results of simulating the behavior of the ink mist M among cases where the air outlet 214 is not provided and where the air outlet 214 from which air is ejected at an ejection speed of 0.25 m/s is provided at different positions that are respectively at distances of 0.3 mm, 1.8 mm, 3.8 mm, and 5.8 mm from the rearmost column of the ink ejection outlet group 210. In FIG. 7, hollow arrows indicate the positions of air ejected from the air outlets 214. As shown in FIG. 7, when air is ejected from the air outlet 214, the ink mist M is forcedly directed toward the base material 9. Thus, it is possible on the downstream side of the air outlet 214 to reduce the amount of the ink mist M adhering to the lower surface 212 of the ink ejection head 21 or the lower surface 31b of the base plate 31.

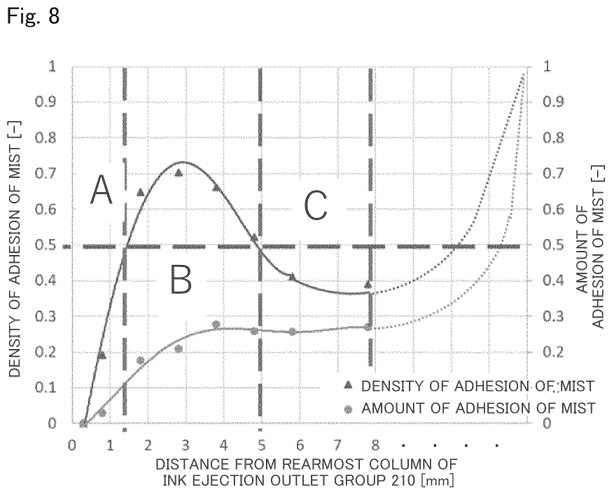

Meanwhile, as shown in FIG. 7, the degree of retention of the ink mist M between the air outlet 214 and the rearmost column of the ink ejection outlet group 210 varies depending on the position of the air outlet 214. FIG. 8 is a graph showing changes in the amount and density of adhesion of mist for cases where the position of the air outlet 214 has been changed. In the graph, solid lines indicate analysis values based on the simulation results, and dotted lines indicate predicted values. Here, the amount of adhesion of mist indicates the total amount of the ink mist M adhering to the lower surface 212 of the ink ejection head 21 between the air outlet 214 and the rearmost column of the ink ejection outlet group 210. The density of adhesion of mist indicates the amount of adhesion of the ink mist M in a region of the lower surface 212 of the ink ejection head 21 to which a largest amount of the ink mist M had adhered, when the lower surface 212 of the ink ejection head 21 between the air outlet 214 and the rearmost column of the ink ejection outlet group 210 is divided into regions of 1 mm in the transport direction. Note that the ink mist M that exists within a distance of 0.25 mm from the lower surface 212 of the ink ejection head 21 in a direction toward the base material 9 is counted as the ink mist M adhering to the lower surface 212 of the ink ejection head 21. Values on first and second axes are relative values when values for the case where the air outlet 214 is not provided are assumed to be one.

Here, the density of adhesion of mist serves as an indicator that represents whether there has not been local adhesion of the ink mist M to part of the lower surface 212 of the ink ejection head 21 due to retention of the ink mist M between the air outlet 214 and the rearmost column of the ink ejection outlet group 210. If the adhesion of the ink mist M is concentrated locally, the ink mist M may accumulate and transform to ink droplets. This increases the possibility that ink droplets may drop on the base material 9. Thus, the density of adhesion of mist may preferably be low.

FIG. 8 shows comparison of the amount and density of adhesion of mist to the lower surface 212 of the ink ejection head 21 for three cases where the air outlet 214 is provided at a distance of 1.4 mm or less from the rearmost column of the ink ejection outlet group 210 (Region A), where the air outlet 214 is provided at a distance of 1.4 mm or more and 5 mm or less from the rearmost column of the ink ejection outlet group 210 (Region B), and where the air outlet 214 is provided at a distance of 5 mm or more and 7.8 mm or less from the rearmost column of the ink ejection outlet group 210 (Region C).

In Region A, the amount of adhesion of mist is reduced to approximately 0.1 times or less the amount of adhesion of mist in the case where the air outlet 214 is not provided, and in Regions B and C, the amount of adhesion of mist is reduced to approximately 0.1 times to 0.3 times the amount of adhesion of mist in case where the air outlet 214 is not provided. In Regions A and C, the density of adhesion of mist is reduced to 0.5 times or less the density of adhesion of mist in the case where the air outlet 214 is not provided, and in Region B, the density of adhesion of mist is reduced to approximately 0.5 times to 0.7 times the density of adhesion of mist in the case where the air outlet 214 is not provided. As described previously, there is a lower possibility that the ink mist M will locally adhere to part of the lower surface 212 of the ink ejection head 21 as the density of adhesin of mist decreases. Thus, when comparison is made between Regions B and C, Region C is more preferable as a position of the air outlet 214.

Accordingly, it is preferable that the air outlet 214 may be provided on the downstream side at a distance of 7.8 mm or less, more preferably at a distance of 1.4 mm or less or at a distance of 5 mm or more and 7.8 mm or less, or yet more preferably at a distance of 1.4 mm or less from the rearmost column of the ink ejection outlet group 210.

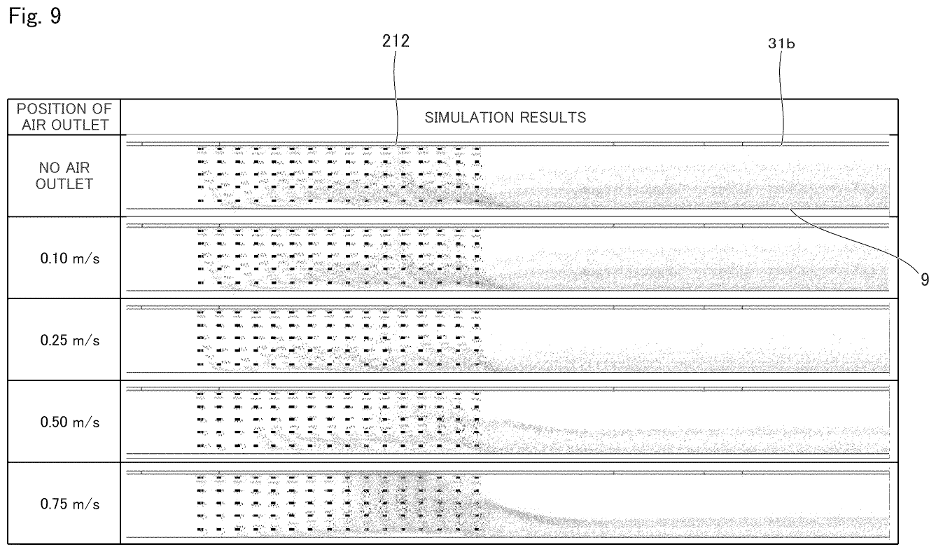

FIG. 9 shows the result of simulating the behavior of the ink mist M when the ejection speed of air has been changed. Here, the air outlet 214 is provided at a distance of 0.3 mm from the rearmost column of the ink ejection outlet group 210 in the transport direction (positions indicated by hollow arrows in FIG. 9). As shown in FIG. 9, as the ejection speed increases, the ink mist M is more directed toward the base material 9 on the more downstream side of the air outlet 214. Meanwhile, on the upstream side of the air outlet 214, the amount of the ink mist M adhering to the lower surface 212 of the ink ejection head 21 increases as the ejection speed increases.

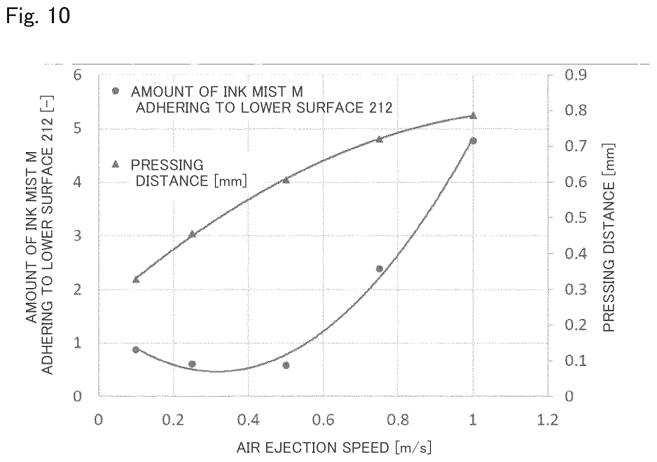

FIG. 10 is a graph showing the behavior of the ink mist M when the ejection speed of air has been changed. Values on the first axis represent the amount of the ink mist M adhering to the lower surface 212 of the ink ejection head 21. Note that the ink mist M that exists at a distance of 0.25 mm or less in a direction from the lower surface 212 of the ink ejection head 21 toward the base material 9 is counted as the ink mist M adhering to the lower surface 212 of the ink ejection head 21, and this value is a relative value when the value for the case where the air outlet 214 is not provided is assumed to be one. Values on the second axis represent the distance in the vertical direction between the lower surface 31b and the ink mist M that exists closest to the lower surface 31b in the vertical direction among the ink mist M existing on the downstream side at a distance of 0.8 mm or more from the rearmost column of the ink ejection outlet group 210, and indicates a pressing distance D by which the air ejected from the air outlet 214 presses the ink mist M downward.

In the case where the ejection speed is in the range of higher than or equal to 0.1 m/s and lower than or equal to 0.55 m/s, the amount of the ink mist M adhering to the lower surface 212 of the ink ejection head 21 is lower than that in the case where the air outlet 214 is not provided, and in particular becomes the lowest at an air velocity of 0.3 m/s. Moreover, since the pressing distance D is maintained at 0.25 mm or more if the ejection speed of air is 0.1 m/s or higher as shown in FIG. 10, there is a low possibility that the ink mist M may adhere to the lower surface 212 of the ink ejection head 21 on the downstream side of the air outlet 214. Accordingly, it is more preferable that the ejection speed of air ejected from the air outlet 214 may be higher than or equal to 0.1 m/s and lower and equal to 0.55 m/s, and may more preferably be 0.3 m/s.

It is also desirable that the air outlet 214 is not provided in the vicinity of the upstream side of the ink ejection outlet group 210. In particular, it is desirable that the air outlet 214 is not provided on the upstream side at a distance of 7.8 mm or less from the forefront column of the ink ejection outlet group 210. In the case where the air outlet 214 is provided in the vicinity of the upstream side of the ink ejection outlet group 210 and caused to eject air, there is a higher possibility that the ink mist M floating in the vicinity of the lower surface 212 of the ink ejection head 21 may rise up and adhere to the lower surface 212 of the ink ejection head 21.

As shown in FIG. 6, an interval d1 between the base material 9 and the lower surface 31b of the base plate 31 is greater than an interval d2 between the base material 9 and the lower surface 212 of the ink ejection head 21. As a result, pressure loss in clearance space between the base material 9 and the lower surface 31b of the base plate 31 on the downstream side of the air outlet 214 becomes lower than pressure loss in clearance space between the base material 9 and the lower surface 212 of the ink ejection head 21 on the upstream side of the air outlet 214. In this way, when the interval d1 on the downstream side of the air outlet 214 is greater than the interval d2 on the upstream side of the air outlet 214, it is possible to easily form an airflow flowing to the downstream side of the air outlet 214. If air from the air outlet 214 is not guided to the downstream side, a downstream airflow caused above the base material 9 by the transport of the base material 9 and by the downflow from the air outlet 214 may be mixed together and produce a turbulent flow. If such a turbulent flow has occurred, the floating ink mist M may rise up and adhere to the base plate 31 or the lower surface 212 of the ink ejection head 21. Therefore, if the airflow flowing to the downstream side is formed by the air outlet 214, it is possible to reduce the adhesion of the ink mist M to the base plate 31 and so on.

Clearance d3 in the air line 215 in the transport direction is smaller than the interval dl between the base material 9 and the lower surface 212 of the ink ejection head 21 on the downstream side of the air outlet 214. Thus, pressure loss in the internal space of the air line 215 becomes higher than the pressure loss in the clearance space between the base material 9 and the lower surface 212 of the ink ejection head 21 on the downstream side of the air outlet 214. Accordingly, the air supplied to the air line 215 is rectified to a downflow having a uniform flow rate in the width direction inside the air line 215, and is ejected from the air outlet 214 toward the base material 9.

In order to form an airflow flowing to the downstream side, the amount of air (flow rate) to be ejected from the air outlet 214 located on the downstream side, among the plurality of air outlets 214, may be smaller than the amount of air to be ejected from the air outlet 214 located on the upstream side. For example, the amount of air to be ejected from the air outlet 214 may be reduced in steps as the distance to the downstream side decreases.

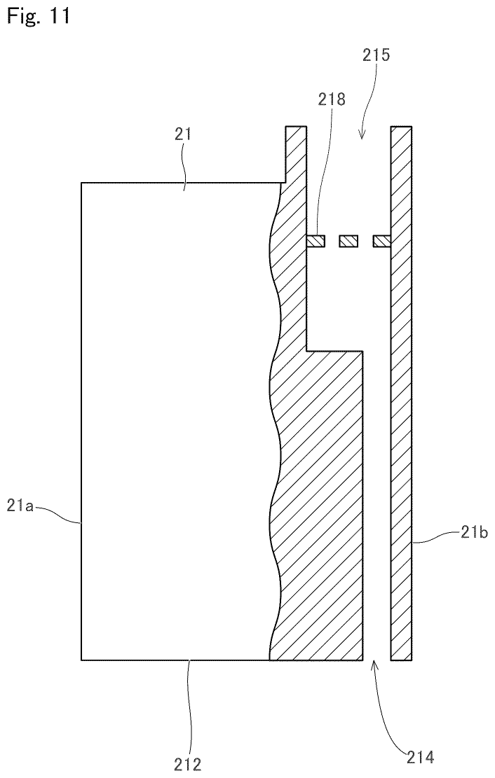

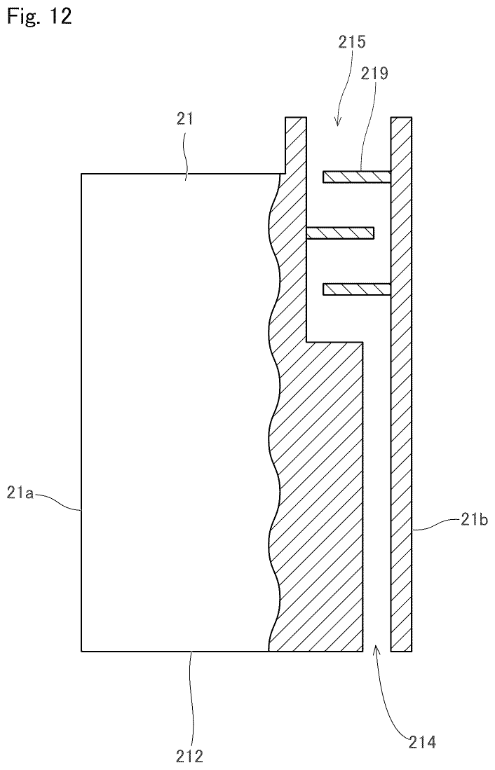

FIG. 11 is a partial sectional view of one ink ejection head 21 when a filter member 218 with air permeability is provided inside the air line 215. FIG. 12 is a partial sectional view of an ink ejection head 21 when straightening vanes 219 for rectifying an airflow is provided inside the air line 215. As shown in FIGS. 11 and 12, the presence of the filter member 218 or the straightening vanes 219 inside the air line 215 increases resistance during passage of air through the air line 215. Accordingly, pressure loss in air in the air line 215 becomes higher than pressure loss in air in the air supply line 162. This allows the flow rate of the air supplied to the air line 215 to be rectified uniformly in the width direction inside the air line 215 and allows the ejection of air from the air outlet 214 toward the base material 9.

Note that the filter member 218 or the straightening vanes 219 may be provided for the purpose of increasing the internal resistance of the air line 215 and reducing the flow rate of air ejected from the air outlet 214. Alternatively, the filter member 218 may be provided for the purpose of purifying the air ejected from the air outlet 214.

### 2. Variations

While the embodiment has been described thus far, the present invention is not intended to be limited to the embodiment described above, and may be modified in various ways.

In the above-described embodiment, the air outlets 214 are slit openings extending in the width direction. Alternatively, the air outlets 214 may, for example, be a plurality of ejection outlets arranged at predetermined intervals in the width direction.

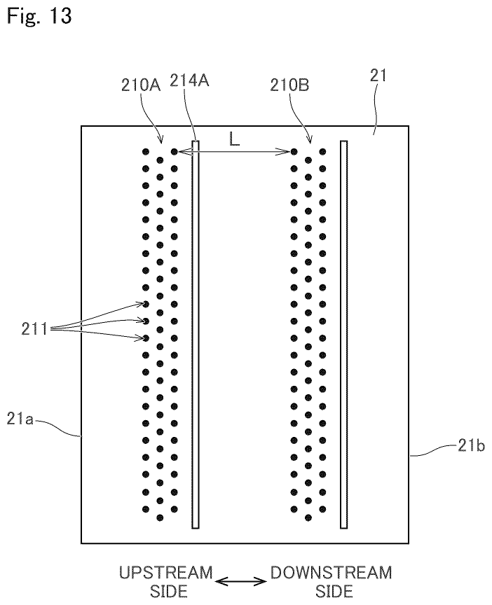

FIG. 13 is a bottom view of one ink ejection head 21 according to a variation. In the above-described embodiment, one ink ejection outlet group 210 is provided on the lower surface 212 for one ink ejection head 21, and one air outlet 214 is provided adjacent to the downstream side of the rearmost column of the ink ejection outlet group 210. However, as shown in FIG. 13, two or more ink ejection outlet groups 210 may be provided overlapping each other in either the transport direction or the width direction for one ink ejection head. Then, for each ink ejection outlet group 210, a plurality of air outlets 214 may be provided adjacent to the downstream side of the rearmost column of the ink ejection outlet group 210.

As described above, it is preferable that the air outlet 214 is not provided in the vicinity of the upstream side of the ink ejection outlet group 210. However, as shown in FIG. 13, there is a case where a first ink ejection outlet group 210A and a second ink ejection outlet group 210B are provided overlapping each other in the transport direction. In this case, an air outlet 214A may be provided in a region in the vicinity of the downstream side of the first ink ejection outlet group 210A, the region being defined as a region located on the downstream side within a distance of L/2 from the rearmost column of the first ink ejection outlet group 210A, where L is the distance between the rearmost column of the first ink ejection outlet group 210A and the forefront column of the second ink ejection outlet group 210B.

In the above-described embodiment, the air line 215 is provided along and in closer proximity to the downstream side face 21b of the ink ejection head 21. However, if the air outlet 214 is provided adjacent to the downstream side of the rearmost column of the ink ejection outlet group 210, the air line 215 may be provided in a region other than the vicinity of the downstream side face 21b of the ink ejection head 21. For example, the air line 215 may be provided so as to pass through the center of the interior of the ink ejection head 21.

In the above-described embodiment, the ink ejection heads 21 of the image recorder 20 eject UV-curable ink to the base material 9. However, the ink ejection heads 21 may eject non-UV-curable ink such as water-based ink to the base material 9.

While the invention has been shown and described in detail, the foregoing description is in all aspects illustrative and not restrictive. It is therefore to be understood that numerous modifications and variations can be devised without departing from the scope of the invention. The configurations of the preferred embodiments and variations described above may be appropriately combined as long as there are no mutual inconsistencies.

### REFERENCE SIGNS LIST

1 inkjet printer
9 base material
9a recording surface
9b back surface
10 base-material transport mechanism
11 unwinder
12 transport roller
13 chilling roller
14 rewinder
15 cleaner
20 image recorder
21 ink ejection head
21a upstream side face
21b downstream side face
26 light irradiator
28 aspirator
30 support unit
31 base plate
31a upper surface
31b lower surface
32 support frame
33 seal member
40 treatment room
50 inert-gas supplier
70 irradiator
80 controller
90 device case
121 switching roller
122 nip roller
151 adsorption roll
161 ink supply line
162 air supply line
171 compressor
172 regulator
210 ink ejection outlet group
210A first ink ejection outlet group
210B second ink ejection outlet group
211 ink ejection outlet
212 lower surface
213 ink line
214 air outlet
214A air outlet
215 air line
218 filter member
219 straightening vanes
311 attachment hole
311a upstream inner wall
311b downstream inner wall
M ink mist
TR transport path

1. An inkjet printer comprising:
a base-material transport mechanism for transporting a base material in a transport direction along a transport path; and
an image recorder that includes an ink ejection head,
wherein the ink ejection head includes:
an ink ejection outlet group that includes a plurality of ink ejection outlets from which ink is ejected toward the base material;
an air outlet that is located downstream of the ink ejection outlet group in the transport direction and from which air is ejected toward the base material;
an ink line through which ink is supplied toward the plurality of ink ejection outlets; and
an air line through which air is supplied toward the air outlet,
the inkjet printer further comprising:
an ink supply line through which ink is supplied toward the ink line of the image recorder; and
an air supply line connected to the air line of the image recorder and through which air is supplied toward the air line,
wherein the air outlet is provided in close proximity to an ink ejection outlet that is located on a most downstream side in the transport direction among the plurality of ink ejection outlets included in the ink ejection outlet group, and
the air outlet is not provided in close proximity to an ink ejection outlet that is located on a most upstream side in the transport direction among the plurality of ink ejection outlets included in the ink ejection outlet group.

2. The inkjet printer according to claim 1, wherein
the air outlet is provided at an interval of 7.8 mm or less in the transport direction from the ink ejection outlet that is located on the most downstream side in the transport direction among the plurality of ink ejection outlets included in the ink ejection outlet group, and
the air outlet is not provided in a region that is within a distance of 7.8 mm or less on the upstream side in the transport direction from the ink ejection outlet that is located on the most upstream side in the transport direction among the plurality of ink ejection outlets included in the ink ejection outlet group.

3. The inkjet printer according to claim 2, wherein
the air outlet is provided at an interval of 1.4 mm or less or at an interval of 5 mm or more and 7.8 mm or less in the transport direction from the ink ejection outlet that is located on the most downstream side in the transport direction among the plurality of ink ejection outlets included in the ink ejection outlet group.

4. The inkjet printer according to claim 1, wherein
air is ejected from the air outlet at a speed of higher than or equal to 0.1 m/s and lower than or equal to 0.55 m/s.

5. The inkjet printer according to claim 1, further comprising:
a filter member located inside the air line and having air permeability.

6. The inkjet printer according to claim 1, further comprising:
straightening values located inside the air line and for rectifying a flow of air passing through an interior of the air line.

7. (canceled)

8. The inkjet printer according to claim 1, further comprising:
an air supply source that supplies high-pressure air to the air supply line.

9. The inkjet printer according to claim 1, wherein
the air supply line is connected to an upper end of the ink ejection head and feeds air into the air line located inside the ejection head.

10. The inkjet printer according to claim 8, wherein
the ink supply line is connected to the upper end of the ejection head at a position on the upstream side in the transport direction from the position of the upper end of the ejection head to which the air supply line is connected.
